(19) United States
(12) Patent Application Publication
(10) Pub. No.: US 2026/0313343 A1
(43) Pub. Date: Oct. 8, 2026

(54) METHOD AND DEVICE FOR DIRECT COMMUNICATION TO SUPPORT PUBLIC WARNING MESSAGE

(71) Applicant: Beijing Xiaomi Mobile Software Co., Ltd., Beijing (CN)

(72) Inventor: Jianning LIU, Beijing (CN)

(73) Assignee: Beijing Xiaomi Mobile Software Co., Ltd., Beijing (CN)

(21) Appl. No.: 19/483,389

(22) PCT Filed: May 12, 2023
(86) PCT No.: PCT/CN2023/094051

§ 371 Date: Nov. 11, 2025

(51) Int. Cl. H04W 4/90; H04W 88/04

(52) U.S. Cl. CPC H04W 4/90; H04W 88/04

(57) ABSTRACT

The present disclosure relates to a method for transmitting a warning message, the method comprises: receiving the warning message from a network; transmitting the warning message to one or more 5G ProSe remote User Equipment, UE, via a UE-to-Network relay discovery announcement message, and/or a relay discovery additional information message.

### CROSS-REFERENCE TO RELATED APPLICATIONS

The present disclosure is a U.S. national phase application of PCT Application No. PCT/CN2023/094051 filed on May 12, 2023, the content of which is hereby incorporated by reference in its entirety.

### TECHNICAL FIELD

The present disclosure relates generally to wireless communications, and more specifically to methods and systems for transmitting, preferably, broadcasting warning messages in a 5G Proximity Services (ProSe) environment.

### BACKGROUND

5G ProSe UE-to-Network (U2N) relay is a vital aspect of modern wireless communication networks. It plays a significant role in broadcasting warning messages from the network to one or more ProSe remote User Equipment (UE).

### SUMMARY

In a first aspect a method is provided for transmitting a warning message, the method may be performed by a ProSe U2N relay. This method includes: receiving the warning message from a network and transmitting the warning message to one or more 5G ProSe remote UE, via a U2N relay discovery announcement message and/or a relay discovery additional information message.

In a second aspect, a method for receiving a warning message is provided, and the method is performed by a User Equipment (UE). The method includes receiving a UE-to-Network relay discovery announcement message and/or a relay discovery additional information message, wherein these messages contain the warning message.

In another aspect of the present disclosure, a system is provided. The system comprises a U2N relay configured to perform the method of transmitting a warning message, a User Equipment (UE) configured to perform the method of receiving a warning message, and a network device configured to broadcast the warning message to the U2N relay.

In another aspect of the present disclosure, a U2N relay is provided. The U2N relay may comprise a memory and a processor, wherein instructions are stored in the memory, which when executed by the processor performs the steps of the method for transmitting a warning message as described before.

In another aspect of the present disclosure, a non-transitory computer-readable storage medium is provided comprising instructions to perform the steps of the method for transmitting a warning message as described before.

In another aspect of the present disclosure, a UE is provided. The UE may comprise a memory and a processor, wherein instructions are stored in the memory, which when executed by the processor, cause the processor to perform the steps of the method for receiving a warning message as described before.

In another aspect of the present disclosure, a non-transitory computer-readable storage medium is provided comprising instructions to perform the steps of the method for receiving a warning message as described before.

In another aspect of the present disclosure, a communication device is provided, comprising: a memory; and a processor, connected to the memory, configured to, by executing computer-executable instructions stored on the memory, control the communication device to perform the steps of the method for transmitting a warning message as described before.

In another aspect of the present disclosure, a communication device is provided, comprising: a memory; and a processor, connected to the memory, configured to, by executing computer-executable instructions stored on the memory, control the communication device to perform the steps of the method for receiving a warning message as described before.

### BRIEF DESCRIPTION OF DRAWINGS

In the following, the present disclosure is described in more detail with reference to the accompanying figures.

FIG. 1 is a flow diagram of the method for transmitting a warning message.

FIG. 2 is a flow diagram of the method for receiving a warning message.

FIG. 3 is a flow diagram of an embodiment according to the present disclosure.

FIG. 4 is a flow diagram of an embodiment according to the present disclosure.

FIG. 5 is a block diagram of a UE-to-Network relay or a UE.

### DETAILED DESCRIPTION

5G ProSe UE-to-Network (U2N) relay is a vital aspect of modern wireless communication networks. It plays a significant role in broadcasting warning messages from the network to one or more ProSe remote User Equipment (UE). However, there are challenges in determining which messages should be broadcasted, particularly when a U2N relay receives a duplicate warning message from the network. Moreover, current mechanisms do not specify which Proximity Services Communication (PC5) message may be used to broadcast such messages, posing a further challenge.

The present disclosure proposes a method for transmitting a warning message and a method for receiving a warning message, ensuring an efficient, robust, and reliable warning message transmission.

A warning message or public warning message (also known as Public Warning System, PWS, message), in the context of the present disclosure and more generally within the field of telecommunications, refers to an alert or notification disseminated via a communication network to inform the public or specific groups of users about potential, imminent, or ongoing emergencies, hazards, or threats.

These messages serve a critical role in public safety, enabling timely dissemination of important alerts and instructions to help people protect themselves and others during emergencies.

In the context of the present disclosure, the 5G ProSe UE-to-Network relay may receive such warning messages from the network and broadcasts them to the 5G ProSe remote UEs using the procedures and mechanisms specified. This ensures that even in situations where certain UEs may not have a direct connection to the network, they can still receive critical warning messages in a timely manner.

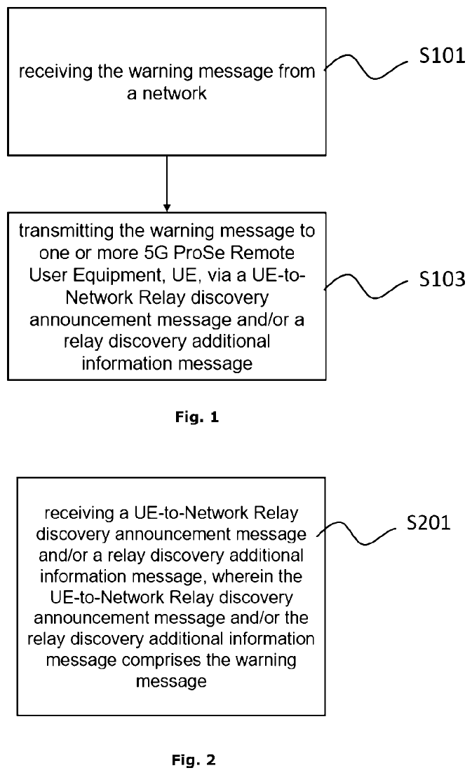

Referring to FIG. 1, FIG. 1 shows a flow diagram according to a method of the disclosure. The method for broadcasting a warning message performed by a U2N relay of FIG. 1 includes steps S101 and S103.
S101 includes receiving the warning message from a network.
S103 includes transmitting the warning message to one or more 5G ProSe remote User Equipment, UE, via a UE-to-Network relay discovery announcement message and/or via a relay discovery additional information message.

Referring to FIG. 2, FIG. 2 shows a flow diagram of another method of the disclosure. The method for receiving a warning message of FIG. 2 is performed by a UE, and includes step S201.
S201 includes receiving a UE-to-Network relay discovery announcement message and/or a relay discovery additional information message, wherein the UE-to-Network relay discovery announcement message and/or the relay discovery additional information message comprises the warning message.

The present disclosure proposes two alternative solutions for transmitting and receiving a warning message. They may be combined.

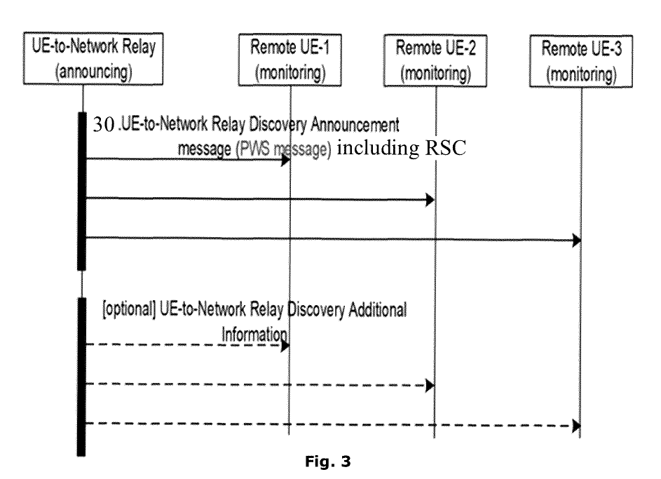

FIG. 3 shows a flow diagram of an embodiment according to the present disclosure which is an enhancement for the U2N relay discovery announcement message during 5G ProSe U2N relay discovery with Model A (as defined in TS. 23.304V18.1.0).

In step 30, the 5G ProSe UE-to-Network relay broadcasts a UE-to-Network relay discovery announcement message. The UE-to-Network relay discovery announcement message may contain the Type of Discovery Message, Announcer Info and RSC, and is sent using the Source Layer-2 ID and Destination Layer-2 ID as described in clause 5.8.3 of TS. 23.304 V18.1.0. The relevant part is herewith incorporated into the present disclosure.

For 5G ProSe Layer-3 UE-to-Network relay, the 5G ProSe Layer-3 UE-to-Network relay may only include an RSC in the UE-to-Network relay discovery announcement when the S-NSSAI associated with that RSC belongs to the Allowed NSSAI of the UE-to-Network relay. In the context of 5G cellular networks, NSSAI stands for Network Slice Selection Assistance Information. It is a set of parameters that are used by the 5G network to provide information to the user equipment (UE) about available network slices, which are virtualized network instances that can be tailored to specific applications or services. S-NSSAI, on the other hand, stands for Single Network Slice Selection Assistance Information. It is a specific type of NSSAI that provides information about a single network slice. The information provided by NSSAI and S-NSSAI may include parameters such as the slice identifier, the slice type, and the quality of service (QoS) requirements for the slice. This information may be used by the UE to select the appropriate network slice based on its requirements and capabilities. Overall, both NSSAI and S-NSSAI are important mechanisms in 5G networks that help to ensure that UEs are connected to the appropriate network slices based on their specific requirements and capabilities. This can help to improve the overall performance and efficiency of the network, while also enabling a wide range of new applications and services.

The 5G ProSe remote UE (1 to 3), shown as Remote UE-1, Remote UE-2, and Remote UE-3 in FIG. 3, determines the Destination Layer-2 ID for signaling reception. The Destination Layer-2 ID is configured with the UE(s) as specified in clause 5.1.4.1 of TS. 23.304 V18.1.0. The relevant part is herewith incorporated into the present disclosure.

5G ProSe remote UE (1 to 3) monitors announcement messages with the 5G ProSe UE-to-Network RSC corresponding to the desired services.

According to the present disclosure, the public warning message is included in the 5G ProSe Layer-3 UE-to-Network relay discovery announcement message.

In the context of the present disclosure and within the field of telecommunications, a remote User Equipment (remote UE) refers to a device in a wireless communication network that is not directly connected to the main network infrastructure but communicates with it through another device, typically a relay.

In this case, a 5G ProSe (Proximity Services) remote UE is a device that relies on the 5G ProSe UE-to-Network (U2N) relay to receive information from and send information to the main 5G network. The relay acts as an intermediary, forwarding or broadcasting information between the network and the remote UEs. This setup can be particularly useful in situations where the remote UEs are out of direct range of the main network or in areas with limited network coverage.

Remote UEs might include devices such as smartphones, tablets, laptops, or any other devices that are equipped to operate within a 5G network and utilize ProSe services. In the context of the present disclosure, the remote UEs are capable of receiving warning messages broadcasted by the 5G ProSe U2N relay, which can be critical for public safety and emergency response scenarios.

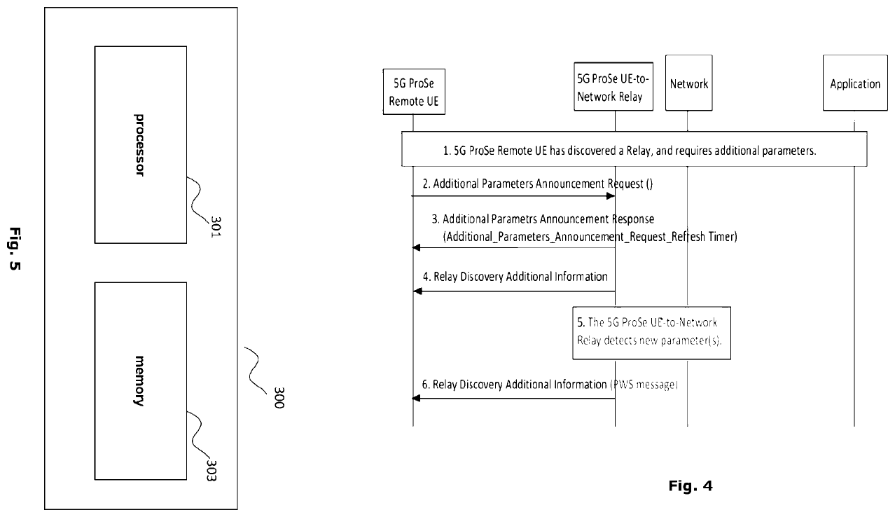

FIG. 4 shows a flow diagram of another embodiment according to the present disclosure which is an enhancement for U2N relay discovery additional information.

In step 1, the 5G ProSe remote UE has discovered a 5G ProSe UE-to-Network relay and requires additional parameters. Such additional parameters may be useful for network management, service configuration, or communication optimization purposes. For example, such additional parameters may include Network Configuration Information: This could include details about the current configuration of the U2N relay or other network devices, changes in the network topology, or other network-specific parameters. Such information can be useful for UEs to optimize their communication strategies. Service Availability Information: The U2N relay might provide information about the availability of certain ProSe services, applications, or resources, which could be useful for UEs in deciding which services to utilize or how to prioritize their activities. Connection and Signal Quality Information: The U2N relay might share details about the quality of the connection or signal strength between different UEs, or between the UEs and the U2N relay itself. This information could be useful in helping UEs manage their connections and optimize their communication strategies. Performance Metrics: The U2N relay might also share certain performance metrics, such as the current load on the U2N relay, latency, packet loss rate, etc. Such information can be used by UEs to adjust their communication strategies for improved performance or efficiency. Software or Firmware Updates: In some cases, the U2N relay might provide information about available software or firmware updates for the UEs, ensuring that all UEs in the network are using the most current and secure software versions.

In the context of the present disclosure, the additional parameters may also refer to any extra information or data that could be relevant or useful in understanding, interpreting, or responding to the warning message being broadcasted. The term is meant to accommodate a wide variety of possible information types that may be useful in different scenarios or for different types of warning messages.

These additional parameters may include, but are not limited to the following. Contextual information about the warning: for instance, this could be more detailed information about the nature of the warning, such as the severity of the threat, the expected duration of the issue, recommended response actions, etc. Technical details: this may include network-specific parameters or ProSe-specific parameters that might affect how the warning message should be interpreted or responded to. Source or destination details: for instance, this could include information about the origin of the warning message or details about which UEs or parts of the network the warning is most relevant to. Timing or scheduling details: this may include information about when the warning was first issued, when it's expected to be updated, how frequently the warning will be re-broadcast, etc.

By including these additional parameters in the relay discovery additional information message, the U2N relay may provide UEs with more comprehensive information about the warning situation, enhancing their ability to respond effectively.

In step 2, subsequently, the 5G ProSe remote UE may send to the 5G ProSe UE-to-Network relay an Additional Parameters Announcement Request to obtain the required additional parameters.

In Step 3, the 5G ProSe UE-to-Network relay may acknowledge receipt of the request in step 2 with an Additional Parameters Announcement Response (Additional_Parameters_Announcement_Request_Refresh Timer). The Additional_Parameters_Announcement_Request_Refresh Timer (configurable in the 5G ProSe UE-to-Network relay), may be provided to the 5G ProSe remote UE so that when this timer expires the 5G ProSe remote UE may repeat the Additional Parameters Announcement Request procedure if it still needs to obtain the additional parameters. If the 5G ProSe remote UE does not initiate a new Additional Parameters Announcement Request procedure when this Additional_Parameters_Announcement_Request_Refresh Timer expires and no other UE request additional parameters announcement before the Additional_Parameters_Announcement_Request_Refresh timer expires in the 5G ProSe UE-to-Network relay, then the relay may stop announcing the additional parameters.

In step 4, the 5G ProSe UE-to-Network relay may announce the additional parameters by sending a relay Discovery Additional Information message as defined in clause 5.8.3 of TS. 23.304 V18.1.0. The relevant part is herewith incorporated into the present disclosure. This may be repeated periodically with a configurable frequency (normally higher than the one related to the Additional_Parameters_Announcement_Request_Refresh Timer) until no UE is requesting to announce the additional parameters as determined by the Additional_Parameters_Announcement_Request_Refresh Timer running in the 5G ProSe UE-to-Network relay.

Based on UE implementation, the 5G ProSe UE-to-Network relay may send the relay Discovery Additional Information message several times consecutively in step 4 if there are other 5G ProSe remote UE(s) that have connected to the 5G ProSe UE-to-Network relay but not yet requested any additional parameters. This ensures the other 5G ProSe remote UE(s) obtain such additional parameters without invoking any new request(s).

In step 5, the 5G ProSe UE-to-Network relay may detect new or updated additional parameters or new public warning messages.

In step 6, detection of new or updated additional parameters in step 5 may trigger the 5G ProSe UE-to-Network relay to announce the additional parameters by sending a relay Discovery Additional Information Message immediately and to repeat it periodically with a configurable frequency as in step 4 until no UEs are requesting to announce the additional parameters, e.g., until the Additional_Parameters_Announcement_Request_Refresh Timer expires in the 5G ProSe UE-to-Network relay.

According to the present disclosure, the public warning message may be included in the 5G ProSe Layer-3 UE-to-Network relay Discovery Additional Information. Preferably, when 5G ProSe Layer-3 UE-to-Network relay determines to broadcast the warning message if it is not a duplicated message.

Reference is now made to FIG. 5, which shows a simplified block diagram of an example embodiment of a device 300 that is one of a UE-to-Network relay or a UE according to the present disclosure. Preferably, the U2N relay is also a UE. The device 300 includes a processor 301 and a memory storage device 303. The memory storage device 303 may store a computer program or application containing instructions that, when executed, causes the processor 301 to perform operations such as those described herein. For example, the instructions may handle public warning message broadcasting and receiving in accordance with the methods described herein. It will be understood that the instructions may be stored on a non-transitory computer-readable medium, such as a compact disc, flash memory device, random access memory, hard drive, etc. When the instructions are executed, processor 301 carries out the operations and functions specified in the instructions so as to operate as a special-purpose processor that implements the described process(es). Such a processor may be referred to as a “processor circuit” or “processor circuitry” in some examples.

The disclosed methods and embodiments provide efficient handling of warning massage in a 5G Proximity Services (ProSe) UE-to-Network relay system, ensuring timely assistance to remote UEs while avoiding resource waste and unnecessary delays.

In a first aspect, a method is provided for transmitting a warning message, the method may be performed by a ProSe U2N relay. This method involves receiving the warning message from a network and subsequently transmitting, preferably, broadcasting the warning message to one or more ProSe remote UEs via a UE-to-Network relay discovery announcement message and/or a relay discovery additional information message. This mechanism allows efficient dissemination of warning messages to a remote user equipment, ensuring critical information is rapidly and effectively communicated. Therein, the UE-to-Network relay discovery announcement message is a specific type of communication that is used in the ProSe environment to announce the presence and capabilities of a ProSe U2N relay. According to the present disclosure, it may be utilized to efficiently broadcast warning messages to a multitude of remote UEs. Similarly, the relay discovery additional information message may also be used to provide the warning message as well. By employing these specific types of messages, the present disclosure ensures an efficient, robust, and reliable warning message, in particular, a public warning message broadcasting system, thereby enhancing safety and awareness in the network. In the description, the term “transmitting” and “broadcasting” may be used interchangeably.

Preferably, the method further comprises: determining whether the received warning message is duplicated and refraining from transmitting the warning message if the warning message is determined to be a duplicated message. Preferably, the warning message is transmitted if the warning message is not a duplicated message. Thus, the embodiment further refines the method by introducing a duplicate message filtering mechanism. If the message is determined to be duplicated, the U2N relay drops the received warning message (i.e., the received message being ignored and the U2N relay does not take any action on it). Therefore, the duplicated message may be disregarded and may not be subjected to any further transmission. This feature significantly reduces unnecessary network traffic and ensures efficient use of network resources, thereby enhancing network performance and reliability. Therein, the “duplicate message” in this context refers to a warning message that has already been received and processed by the ProSe U2N relay. The determination process may involve comparing the incoming message with previously received messages based on certain parameters or identifiers inherent in the messages. For example, the determining step may include analyzing a unique identifier associated with the warning message. The unique identifier may be a sequence number or a timestamp associated with the warning message. If such unique identifier is the same, then the messages are considered to be duplicated.

Preferably, if the warning message is transmitted via the relay discovery additional information message, the method further comprises: receiving an additional parameters announcement request from a ProSe remote UE and responding with an additional parameters announcement response. Thus, it further expands on the method when the warning message is broadcasted via the relay discovery additional information message. It entails the ProSe U2N relay receiving an additional parameters announcement request from a ProSe remote UE and responding with an additional parameters announcement response. This interaction enables the ProSe remote UE to request and receive further information, which may also be related to the warning situation, thereby contributing to a comprehensive understanding of the warning scenario and more effective decision-making. To note, the terms “additional parameters announcement request” and “additional parameters announcement response” refer to specific types of ProSe communication messages used in the interaction between a ProSe U2N relay and a ProSe remote UE. These messages may enable the relay and the remote UE to exchange additional information about the network or warning situation, enhancing the effectiveness of the warning message broadcasting process.

In a second aspect a method is provided for receiving a warning message, the method is performed by a User Equipment (UE). The method includes receiving a UE-to-Network relay discovery announcement message and/or a relay discovery additional information message, wherein these messages contain the warning message. This method ensures that the UE can efficiently receive and process warning messages from a U2N relay, improving the overall effectiveness of the warning system in the ProSe environment. To elaborate, the UE-to-Network relay discovery announcement message and the relay discovery additional information message represent the two main channels through which a UE can receive warning messages. By monitoring these specific types of messages, the UE can promptly and accurately receive critical warning information, enhancing its ability to respond to potential threats or emergency situations.

Preferably, the method further involves the UE transmitting an additional parameters announcement request to the U2N relay and receiving an additional parameters announcement response. This mechanism further facilitates the exchange of the warning message along with the additional information between the U2N relay and the UE, ensuring a more comprehensive understanding of the warning situation at the UE side. Therein, the “additional parameters announcement request” and the “additional parameters announcement response” are specific types of ProSe messages that enable the UE and the U2N relay to interact and exchange more detailed information, preferably information about the warning situation. This feature may enhance the effectiveness and comprehensiveness of the warning message broadcasting system, ensuring UEs are fully informed and capable of making appropriate decisions based on the warning messages received.

In another aspect of the present disclosure, a system is provided, the system comprising a U2N relay configured to perform the method of transmitting a warning message, a User Equipment (UE) configured to perform the method of receiving a warning message, and a network device configured to broadcast the warning message to the U2N relay. This system represents a complete ProSe environment capable of efficient and effective warning message broadcasting, reception, and processing, enhancing the overall safety and awareness in the network. In particular, the system integrates the functionality of the U2N relay, UE, and network device to facilitate the broadcasting, reception, and processing of warning messages. Through the seamless interaction of these components, the system can efficiently manage the flow of critical warning information, ensuring rapid and accurate dissemination of these messages to all relevant parties within the network. This results in improved network safety and robustness, particularly in situations where timely delivery of warning messages is crucial.

In another aspect of the present disclosure, a U2N relay is provided. The U2N relay may comprise a memory and a processor, wherein instructions are stored in the memory, which when executed by the processor performs the steps of the method for transmitting a warning message as described herein.

In another aspect of the present disclosure, a computer-readable storage medium is provided comprising instructions to perform the steps of the method for transmitting a warning message as described herein.

In another aspect of the present disclosure, a computer program is provided comprising instructions which, when the program is executed by a UE-to-Network, U2N, relay, cause the U2N relay to carry out the method for transmitting a warning message as described herein.

In another aspect of the present disclosure, a UE is provided. The UE may comprise a memory and a processor, wherein instructions are stored in the memory, which when executed by the processor performs the steps of the method for receiving a warning message as described herein.

In another aspect of the present disclosure, a computer-readable storage medium is provided comprising instructions to perform the steps of the method for receiving a warning message as described herein.

In another aspect of the present disclosure, a computer program is provided comprising instructions which, when the program is executed by a UE, cause the UE to carry out the method for receiving a warning message as described herein.

Certain adaptations and modifications of the described embodiments can be made. Therefore, the above-discussed embodiments are considered to be illustrative and not restrictive. In particular, embodiments can be freely combined with each other.

1. A method for transmitting a warning message, performed by a 5G Proximity Services (ProSe) UE-to-Network (U2N) relay, comprising:
receiving the warning message from a network; and
transmitting the warning message to one or more 5G ProSe remote User Equipment (UE), via at least one of a U2N relay discovery announcement message or a relay discovery additional information message.

2. The method of claim 1, further comprising:
determining whether the received warning message is duplicated; and
refraining from transmitting the warning message if the warning message is determined to be a duplicated message.

3. The method of claim 1, on a condition that the warning message is transmitted via the relay discovery additional information message, the method further comprises:
receiving an additional parameters announcement request from the one or more 5G ProSe remote UEs; and
responding with an additional parameters announcement response to the one or more 5G ProSe remote UEs.

4. A method for receiving a warning message, performed by a User Equipment (UE), comprising:
receiving at least one of a UE-to-Network (U2N) relay discovery announcement message or a relay discovery additional information message, and
wherein the at least one of the U2N relay discovery announcement message or the relay discovery additional information message comprises the warning message.

5. The method of claim 4, wherein on a condition that the relay discovery additional information message comprises the warning message, the method further comprises:
transmitting an additional parameters announcement request to a 5G Proximity Services (ProSe) U2N relay; and
receiving an additional parameters announcement response from the 5G ProSe U2N relay.

6. A UE-to-Network (U2N) relay, configured to:
receive a warning message from a network; and
transmit the warning message to one or more 5G Proximity Services (ProSe) remote User Equipment (UE), via at least one of a U2N relay discovery announcement message or a relay discovery additional information message.

7. A User Equipment (UE), configured to perform the method of claim 4.

8-9. (canceled)

10. A non-transitory computer-readable medium comprising instructions which, when executed by a UE-to-Network (U2N) relay, cause the U2N relay to perform the method of claim 1.

11. A non-transitory computer-readable medium comprising instructions which, when executed by a User Equipment (UE), cause the UE to carry out the method of claim 4.

12. A system comprising:
a UE-to-Network (U2N) relay, configured to:
receive a warning message from a network, and
transmit the warning message to one or more 5G Proximity Services (ProSe) User Equipment (UE), via at least one of a U2N relay discovery announcement message or a relay discovery additional information message;
a UE configured to perform the method of claim 4; and
a network device, configured to transmit the warning message to the U2N relay.

13. A communication device, comprising:
a memory; and
a processor, connected to the memory, configured to, by executing computer-executable instructions stored on the memory, control the communication device to perform the method of claim 1.

14. A communication device, comprising:
a memory configured to store computer-executable instructions; and
a processor, communicatively coupled to the memory, configured to execute the computer-executable instructions to control the communication device to perform the method of claim 4.

15. The U2N relay of claim 6, further configured to:
determine whether the received warning message is duplicated; and
refrain from transmitting the warning message if the warning message is determined to be a duplicated message.

16. The U2N relay of claim 6, further configured to, on a condition that the warning message is transmitted via the relay discovery additional information message,
receive an additional parameters announcement request from the one or more 5G ProSe remote UEs; and
respond with an additional parameters announcement response to the one or more 5G ProSe remote UEs.
